(19) United States
(12) Patent Application Publication
(10) Pub. No.: US 2004/0255760 A1
(43) Pub. Date: Dec. 23, 2004

(54) PORTABLE MUSIC PLAYER FOR USE WITH REMOVABLE MEMORY DEVICE

(76) Inventor: Chieh-Yuan Cheng, Tao-Yuan City (TW)

Correspondence Address: NAIPO (NORTH AMERICA INTERNATIONAL PATENT OFFICE), P.O. BOX 506, MERRIFIELD, VA, 22116, US

(21) Appl. No.: 10/250,250

(22) Filed: Jun. 17, 2003

(51) Int. Cl. H04Q 1/00; G10H 7/00; G10H 1/18

(52) U.S. Cl. 84/615

(57) ABSTRACT

A portable music player includes an external memory connector for connecting to a removable memory device containing digital music files, a user interface operable to allow a user to select and access the digital music files stored in the removable memory device, a decoder for converting selected digital music files into audio signals, and an audio output port for outputting the audio signals.

### BACKGROUND OF INVENTION

1. Field of the Invention

The present invention relates to a portable music player, and more specifically, to a portable music player used in conjunction with a plurality of removable storage devices, the removable storage devices each containing digital music files to be played on the portable music player.

2. Description of the Prior Art

With the advent of digital music being readily available, users have a new source of musical content. Digital music content resides in relatively small digital files that can be stored on portable non-volatile memory devices. Due to the popularity of digital music, portable music players such as Moving Pictures Expert Group, Layer 3 (MP3) players, as well as other types of music players can be found everywhere.

Please refer to FIG. 1 and FIG. 2. FIG. 1 is a diagram of a portable music player 10 according to the prior art. FIG. 2 is a functional block diagram of the portable music player 10 shown in FIG. 1. The portable music player 10 contains a memory 16 such as a flash memory for storing digital music files. Currently, music files in the MP3 format are commonly used in the portable music player 10 due to their small file sizes. The portable music player 10 contains an external connector 14 such as a male USB connector for allowing the portable music player 10 to connect to a host device such as a computer. The portable music player 10 connects to the host device for transferring digital music files from the computer to the portable music player 10, and vice versa. A controller 20 is used for controlling operations of the portable music player 10. The portable music player 10 contains a decoder 18 for converting the digital music files stored in the memory 16 into analog audio signals. In addition to playing digital music files stored in the memory 16, the portable music player 10 also contains a radio receiver 22 for playing radio signals received on FM and AM radio stations.

The portable music player 10 contains a display 12 for indicating an operating state of the portable music player 10 to a user. For instance, the title of the current song or the radio station being played can be indicated on the display 12 along with information about the battery life of the portable music player 10. An audio output port 24 allows the user to hear the music being played on the portable music player 10. The audio output port 24 is typically an earphone jack, although a speaker can be used instead of or in addition to the earphone jack.

The portable music player 10 is popular for its small size and its simple design with no moving parts. However, the portable music player 10 has a fixed amount of memory 16 available for storing digital music. As an example, suppose that the memory 16 has a capacity of 64 MB, which can store about one hour of digital music in the MP3 format. If the user of the portable music player 10 wishes to go on an extended trip, he will quickly run out of new songs to listen to on the portable music player 10 due to the small capacity of the memory 16. In addition, if the user wishes to change the songs on the portable music player 10, the user must connect the portable music player 10 to the host device for updating the songs stored in the memory 16 of the portable music player 10. During this updating process, the host computer treats the portable music player 10 as a slave device, and controls all file transferring processes. It should be noted that the user interface of the portable music player 10 cannot be used to read files on the host computer. The portable music player 10 can only read files once they are stored in the memory 16 of the portable music player 10. The portable music player 10 cannot be freely carried around during process of updating the songs in the memory 16. In order to overcome these problems, the user must buy multiple portable music players 10. If two or more portable music players 10 are used, one portable music player 10 can be freely carried around and listened to while another portable music player 10 is updated with a host device. Unfortunately, having more than one portable music player 10 greatly increases the cost associated with enjoying digital music.

### SUMMARY OF INVENTION

It is therefore a primary objective of the claimed invention to provide a portable music player that can be connected to a removable memory device in order to solve the above-mentioned problems.

According to the claimed invention, a portable music player includes an external memory connector for connecting to a removable memory device containing digital music files, a user interface operable to allow a user to select and access the digital music files stored in the removable memory device, a decoder for converting selected digital music files into audio signals, and an audio output port for outputting the audio signals.

It is an advantage of the claimed invention that the portable music player can be connected to removable memory devices for eliminating constraints on a capacity of the memory of the portable music player. A user may use as many removable memory devices as necessary for storing digital music, and can simply insert a chosen removable memory device into the portable music player to listen to songs on the chosen removable memory device.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a portable music player according to the prior art.

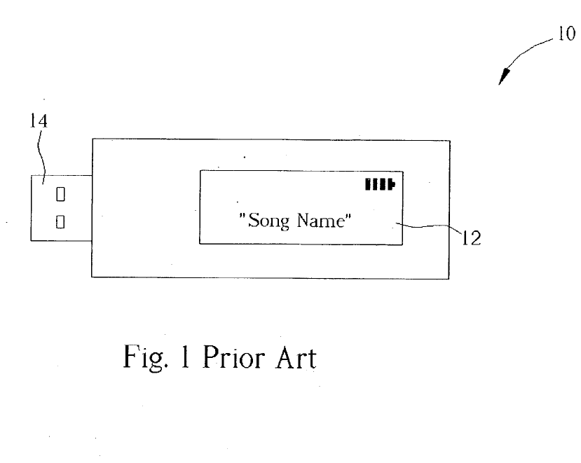

FIG. 2 is a functional block diagram of the portable music player shown in FIG. 1.

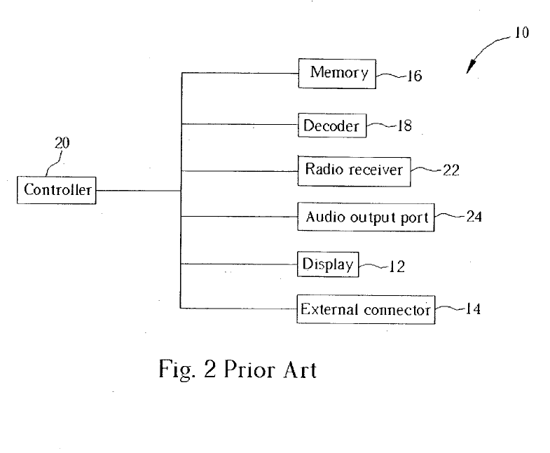

FIG. 3 is a diagram of a portable music player connected to a removable memory device according to the present invention.

FIG. 4 is a functional block diagram of the portable music player and the removable memory device shown in FIG. 3.

### DETAILED DESCRIPTION

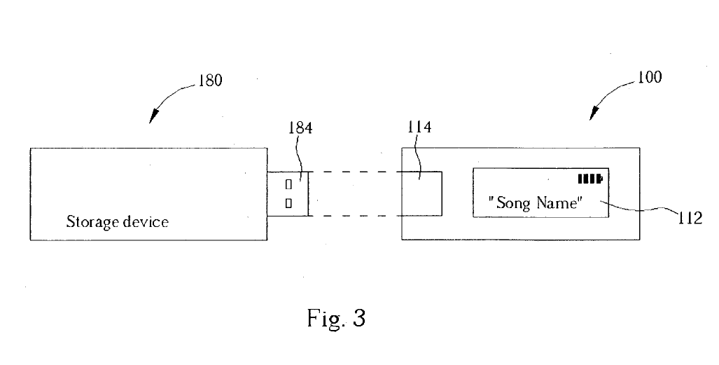

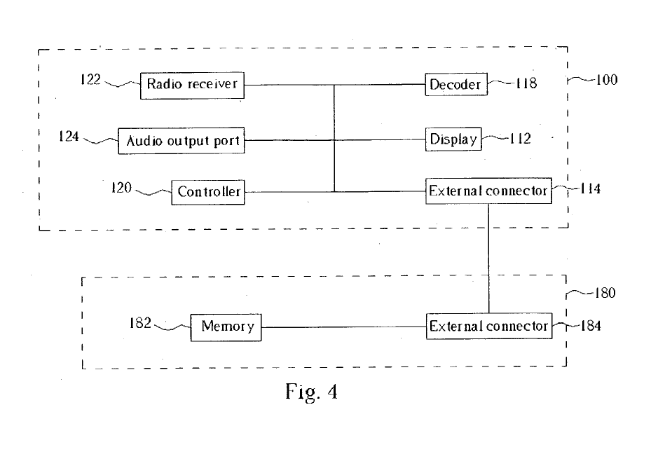

Please refer to FIG. 3 and FIG. 4. FIG. 3 is a diagram of a portable music player 100 connected to a removable memory device 180 according to the present invention. FIG. 4 is a functional block diagram of the portable music player 100 and the removable memory device 180 shown in FIG. 3. The portable music player 100 of the present invention is similar to the portable music player 10 of the prior art. However, the portable music player 100 is capable of connecting to the removable memory device 180 for increasing the memory capacity of the portable music player 100. The removable memory device 180 contains a memory 182 for storing digital music. Please note that the removable memory device 180 can be realized with a standard off-the-shelf USB portable storage device, which usually contains flash memory for the memory 182. The portable music player 100 contains a first external connector 114 for connecting to a second external connector 184 of the removable memory device 180. The first external connector 114 is preferably a female USB connector and the second external connector 184 is preferably a male USB connector, as shown in FIG. 3.

One or more removable memory devices 180 can be used in conjunction with the portable music player 100 for storing digital music that can be played through the portable music player 100. In this way, the portable music player 100 has no limit on the amount of memory that can be used to store digital music. The removable memory device 180 can be connected to a host computer for downloading digital music onto the memory 182 of the removable memory device 180. Once the desired digital music is stored on the memory 182, the removable memory device 180 can be disconnected from the host device and connected to the portable music player 100. Once the removable memory device 180 is connected to the portable music player 100, the portable music player 100 treats the removable memory device 180 as a slave device, and the user interface of the portable music player 100 allows files to be selected and read from the memory 182 of the removable memory device 180 through the first external connector 114 and the second external connector 184.

A controller 120 is used for controlling operations of the portable music player 100. The portable music player 100 contains a decoder 118 for converting the digital music files stored in the memory 182 into analog audio signals. The decoder 118 may be capable of decoding more than one format of digital music, such as the MP3 and Windows Media Audio (WMA) formats, into analog audio signals. In addition to playing digital music files stored in the memory 182, the portable music player 100 also contains a radio receiver 122 for playing radio signals received on FM and AM radio stations.

The portable music player 100 contains a display 112 for indicating an operating state of the portable music player 100 to a user. For instance, the title of the current song or the radio station being played can be indicated on the display 112 along with information about the battery life of the portable music player 100. An audio output port 124 allows the user to hear the music being played on the portable music player 100. The audio output port 124 is typically an earphone jack, although a speaker can be used instead of or in addition to the earphone jack.

When the portable music player 100 is not connected to the removable memory device 180, the portable music player 100 can still be used to listen to the radio through the radio receiver 122. If the portable music player 100 does not contain any internal memory, the removable memory device 180 has to be connected to the portable music player 100 in order to listen to digital music songs stored on the memory 182. Alternatively, the portable music player 100 can be designed to contain optional internal memory, which would allow the user to listen to songs while the removable memory device 180 is temporarily disconnected from the portable music player 100.

Compared to the prior art portable music player 10, the present invention portable music player 100 is not limited to a fixed size memory capacity. A plurality of removable memory devices 180 can be used in conjunction with the portable music player 100 to provide a limitless amount of memory that can be used to store digital music. Therefore, only one portable music player 100 is needed, and the removable memory device 180 can be bought independently using off-the-shelf portable storage devices. Since there is no limit to the size of the memory that can be used to store digital music played through the portable music player 100, users can always be assured of having enough music to listen to on long trips.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A portable music player for use in conjunction with a removable memory device, the removable memory device comprising a memory for storing digital music files and a first electrical connector for transmitting the digital music files to and from the memory, the portable music player comprising: a second electrical connector removably connected with the first electrical connector of the removable memory device; a user interface operable to allow a user to select and access the digital music files stored in the memory of the removable memory device through the first and second electrical connectors;
a decoder for converting selected digital music files into audio signals; and an audio output port for outputting the audio signals.

2. The portable music player of claim 1 wherein the second electrical connector is a serial bus connector for communicating with the first electrical connector of the removable memory device serially.

3. The portable music player of claim 2 wherein the first and second electrical connectors are universal serial bus (USB) connectors.

4. The portable music player of claim 3 wherein the second electrical connector is a female USB connector and the first electrical connector is a male USB connector.

5. The portable music player of claim 2 wherein the first and second electrical connectors are IEEE 1394 serial bus connectors.

6. The portable music player of claim 1 wherein the decoder is an MP3 decoder.

7. The portable music player of claim 1 wherein the decoder is a digital-to-analog decoder and the audio signals are analog.

8. The portable music player of claim 1 wherein the audio output port is an earphone jack.

9. The portable music player of claim 1 wherein the audio output port is electrically connected to a speaker for outputting analog audio signals.

10. The portable music player of claim 1 further comprising a radio receiver for receiving radio signals and for outputting corresponding analog audio signals to the audio output port.

11. The portable music player of claim 1 wherein the removable memory device comprises flash memory for storing the digital music files.

12. The portable music player of claim 1 wherein the removable memory device is a USB portable storage device.

13. A portable music player for use in conjunction with a universal serial bus (USB) portable storage device, the USB portable storage device comprising a memory for storing digital music files and a first USB connector for transmitting the digital music files to and from the memory, the portable music player comprising:
a second USB connector removably connected with the first USB connector of the USB portable storage device;
a user interface operable to allow a user to select and access the digital music files stored in the memory of the USB portable storage device through the first and second USB connectors;
a decoder for converting selected digital music files into audio signals; and an audio output port for outputting the audio signals.

14. The portable music player of claim 13 wherein the second USB connector is a female USB connector and the first USB connector is a male USB connector.

15. The portable music player of claim 13 wherein the decoder is an MP3 decoder.

16. The portable music player of claim 13 wherein the decoder is a digital-to-analog decoder and the audio signals are analog.

17. The portable music player of claim 13 wherein the audio output port is an earphone jack.

18. The portable music player of claim 13 wherein the audio output port is electrically connected to a speaker for outputting analog audio signals.

19. The portable music player of claim 13 further comprising a radio receiver for receiving radio signals and for outputting corresponding analog audio signals to the audio output port.

20. The portable music player of claim 13 wherein the USB portable storage device comprises flash memory for storing the digital music files.

21. A portable music player for use in conjunction with a removable memory device, the removable memory device comprising a flash memory for storing digital music files and a first electrical connector for transmitting the digital music files to and from the flash memory, the portable music player comprising:
a second electrical connector removably connected with the first electrical connector of the removable memory device;
a user interface operable to allow a user to select and access the digital music files stored in the flash memory of the removable memory device through the first and second electrical connectors;
an MP3 decoder for converting selected digital music files into audio signals; and
an audio output port for outputting the audio signals.

22. The portable music player of claim 21 wherein the second electrical connector is a serial bus connector for communicating with the first electrical connector of the removable memory device serially.

23. The portable music player of claim 22 wherein the first and second electrical connectors are universal serial bus (USB) connectors.

24. The portable music player of claim 23 wherein the second electrical connector is a female USB connector and the first electrical connector is a male USB connector.

25. The portable music player of claim 22 wherein the first and second electrical connectors are IEEE 1394 serial bus connectors.

26. The portable music player of claim 21 wherein the audio output port is an earphone jack.

27. The portable music player of claim 21 wherein the audio output port is electrically connected to a speaker for outputting analog audio signals.

28. The portable music player of claim 21 further comprising a radio receiver for receiving radio signals and for outputting corresponding analog audio signals to the audio output port.

29. The portable music player of claim 21 wherein the removable memory device is a USB portable storage device.

30. A portable music player system comprising: a digital memory system comprising:
a non-volatile memory device storing a digital music file; and
a first electrical connector formed on the digital memory system; and
a portable music player comprising:
a second electrical connector formed on the portable music player for removably connecting to the first connector; a user interface for allowing a user to access the digital music
file stored in the non-volatile memory through the first and second electrical connectors;
a decoder for converting the digital music file into audio signals; and
an audio output port for outputting the audio signals.

31. The portable music player system of claim 30 wherein the second electrical connector is a serial bus connector for communicating with the first electrical connector serially.

32. The portable music player system of claim 31 wherein the first and second electrical connectors are universal serial bus (USB) connectors.

33. The portable music player system of claim 32 wherein the second electrical connector is a female USB connector and the first electrical connector is a male USB connector.

34. The portable music player system of claim 31 wherein the first and second electrical connectors are IEEE 1394 serial bus connectors.

35. The portable music player system of claim 30 wherein the decoder is an MP3 decoder.

36. The portable music player system of claim 30 wherein the audio output port is an earphone jack.

37. The portable music player system of claim 30 further comprising a radio receiver for receiving radio signals and for outputting corresponding analog audio signals to the audio output port.

38. The portable music player system of claim 30 wherein the non-volatile memory device of the digital memory system is a flash memory.

39. The portable music player system of claim 30 wherein the digital memory system is a USB portable storage device.
